(19) United States
(12) Patent Application Publication
(10) Pub. No.: US 2014/0214934 A1
(43) Pub. Date: Jul. 31, 2014

(54) Composition Engine as a Service

(71) Applicants: Matthias Tebbe, Walldorf (DE); Juergen Kremer, Wiesloch (DE); Joerg Singler, Zeutern (DE); Jobin John, Kochi (IN)

(72) Inventors: Matthias Tebbe, Walldorf (DE); Juergen Kremer, Wiesloch (DE); Joerg Singler, Zeutern (DE); Jobin John, Kochi (IN)

(21) Appl. No.: 13/751,513

(22) Filed: Jan. 28, 2013

(51) Int. Cl. H04L 29/08

(52) U.S. Cl. CPC H04L 67/20
USPC 709/204

(57) ABSTRACT

A method includes: providing a composition engine as a service configured to receive requests from multiple service consumers using any of multiple service consumer protocols; receiving a first request in the composition engine as a service conforming to a service consumer protocol from a service consumer operated by a customer; generating a second request to each of one or more provider systems, the second request conforming to a provider system protocol, the composition engine as a service configured to generate requests conforming to any of multiple provider system protocols; receiving, by the composition engine as a service, information from the provider system, and adapting the received information to conform to the service consumer protocol; and exposing, by the composition engine as a service, a web service that makes the adapted information available to the service consumer.

### BACKGROUND

Some companies or other organizations arrange their operations according to one or more business process model. Such a model can be defined by a plurality of tasks that may be accessed or otherwise performed during use. This can involve using services and/or engines, such as via a web-based composition platform. For example, a widget can be implemented that is operable to communicate with one or more services.

### SUMMARY

In a first aspect, a computer-implemented method for providing a composition engine as a service includes: providing a composition engine as a service, the composition engine as a service configured to receive requests from multiple service consumers using any of multiple service consumer protocols; receiving a first request in the composition engine as a service from a service consumer operated by a customer, the first request conforming to a service consumer protocol; generating, by the composition engine as a service and in response to the first request, a second request to each of one or more provider systems, the second request conforming to a provider system protocol, the composition engine as a service configured to generate requests conforming to any of multiple provider system protocols; receiving, by the composition engine as a service, information from the provider system, and adapting the received information to conform to the service consumer protocol; and exposing, by the composition engine as a service, a web service that makes the adapted information available to the service consumer.

In a second aspect, a computer program product is embodied in a non-transitory computer-readable storage medium and includes instructions that when executed by a processor perform a method for providing a composition engine as a service. The method includes: providing a composition engine as a service, the composition engine as a service configured to receive requests from multiple service consumers using any of multiple service consumer protocols; receiving a first request in the composition engine as a service from a service consumer operated by a customer, the first request conforming to a service consumer protocol; generating, by the composition engine as a service and in response to the first request, a second request to each of one or more provider systems, the second request conforming to a provider system protocol, the composition engine as a service configured to generate requests conforming to any of multiple provider system protocols; receiving, by the composition engine as a service, information from the provider system, and adapting the received information to conform to the service consumer protocol; and exposing, by the composition engine as a service, a web service that makes the adapted information available to the service consumer.

In a third aspect, a system includes: one or more processors; and a computer program product embodied in a non-transitory computer-readable storage medium and including instructions that when executed by a processor perform a method for providing a composition engine as a service. The method includes: providing a composition engine as a service, the composition engine as a service configured to receive requests from multiple service consumers using any of multiple service consumer protocols; receiving a first request in the composition engine as a service from a service consumer operated by a customer, the first request conforming to a service consumer protocol; generating, by the composition engine as a service and in response to the first request, a second request to each of one or more provider systems, the second request conforming to a provider system protocol, the composition engine as a service configured to generate requests conforming to any of multiple provider system protocols; receiving, by the composition engine as a service, information from the provider system, and adapting the received information to conform to the service consumer protocol; and exposing, by the composition engine as a service, a web service that makes the adapted information available to the service consumer.

Implementations can include any or all of the following features. The first request is received, in the composition engine as a service, by a client request handler that interprets the first request and routes the first request to an associated module. The method further includes adapting the service consumer protocol, by a protocol adapter in the composition engine as a service, into an internal format for the composition engine as a service. The internal format is for a component that includes an adaptation engine configured to adapt the received information to conform to the service consumer protocol, the adaptation engine using an adaptation model and not using domain-specific code associated with a domain of the provider system. The component includes domain-specific code associated with a domain of the provider system. The domain-specific code is also tenant-specific to the customer. The method further includes receiving, in the composition engine as a service, a request from the service consumer that identifies two or more web services provided by the composition engine as a service, composing, by the composition engine as a service, a single web service from the identified two or more web services, and exposing, by the composition engine as a service, the composed single web service to the service consumer.

Implementations can provide any or all of the following advantages. A system can be provided that provides web services that fit to a specific consumption scenario and that are accessible via a public network (e.g., the internet). A system can provide capability to retrieve required information out of a heterogeneous system environment (e.g., from an enterprise resource planning system or a relational database). A system can provide capability to add domain specific logic for service adaptation. A system can provide capability to compose one service out of a set of services. A system can be provided that reduces the operating expenses for providing services, such as those described herein, by allowing a hosted development of the infrastructure that processes the service.

The details of one or more implementations are set forth in the accompanying drawings and the description below. Other features and advantages will be apparent from the description and drawings, and from the claims.

### DESCRIPTION OF DRAWINGS

FIG. 1 shows an example of a system where a Composition Engine as a Service exposes one or more web services.

FIG. 2 shows an example of a Composition Engine as a Service.

FIG. 3 shows an example of a method.

FIG. 4 is a block diagram of a computing system that can be used in connection with computer-implemented methods described in this document.

Like reference symbols in the various drawings indicate like elements.

### DETAILED DESCRIPTION

This document describes systems and techniques for providing a Composition Engine as a Service (CEaaS). For example, the CEaaS can be implemented using a hosted system that is publicly accessible, such as through the internet, and that supports multiple tenants so that the infrastructure costs are distributed over more than one entity.

Each tenant can then use the CEaaS to connect to one or more systems (e.g., provider systems, such as application systems), which provide information that the tenants wish to consume. For example, the CEaaS can expose such information as a web service to the tenant(s). Mobile and other web-enabled devices use varying operating systems and form factors. This can make it a relatively complex and costly task to provide native clients applications for two or more device types. Also, business-relevant applications often require sharing of data, which must be requested from a server.

The information that such client applications require is often persisted in a heterogeneous system landscape. In some implementations, information may only be accessible using proprietary protocols, proprietary formats and/or heterogeneous protocols. Examples of protocols include, but are not limited to, remote function call (RFC) protocol used by SAP AG, Java database connectivity (JDBC) protocol, and simple object access protocol (SOAP). In some implementations, a component is provided (e.g., a server component) that adapts the heterogeneous or proprietary protocols to a standardized protocol that is used at all relevant client platforms. The component can provide ability to process use-case specific logic to create services with enhanced functionality. The component can harmonize the access by client applications to required information.

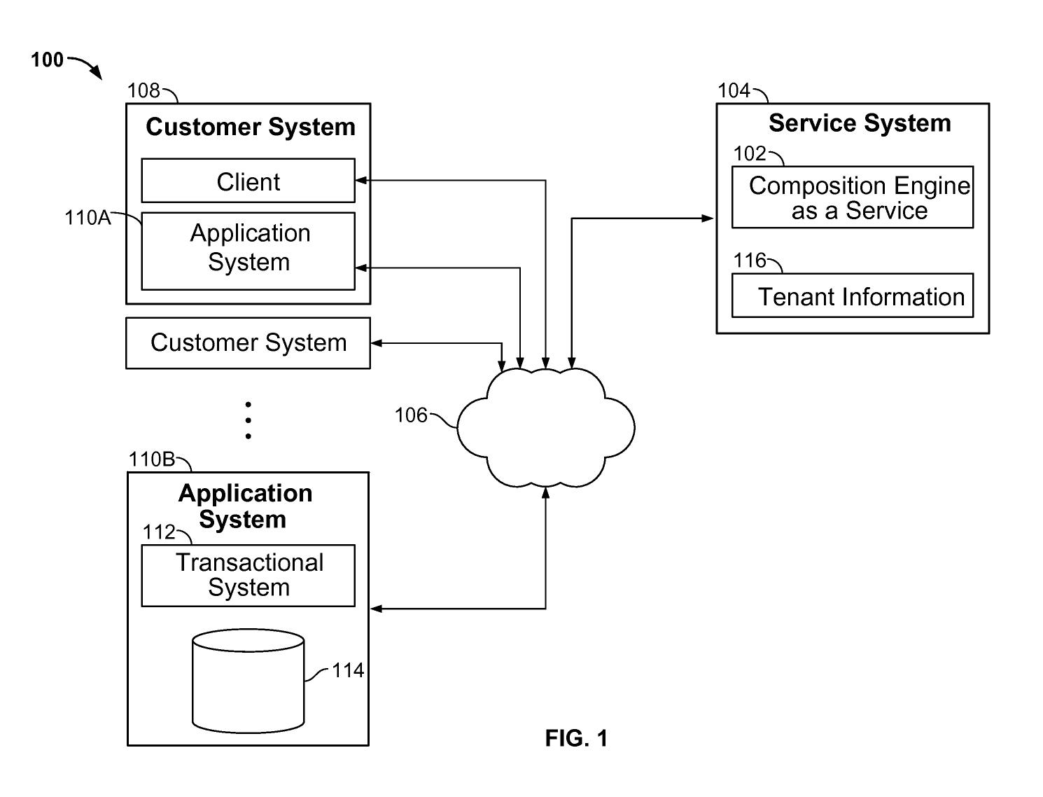

FIG. 1 shows an example of a system 100 where a CEaaS 102 exposes one or more web services. Here, the CEaaS 102 is implemented in a service system 104 connected to one or more networks 106, such as, but not limited to, a local area network or the internet. For example, the service system 104 can function as a Gateway as a Service (GaaS), and/or, in some implementations, an Integration as a Service (IaaS) system. The CEaaS exposes the web service(s) to customers to aid the connection between various native client applications and provider systems using proprietary and/or heterogeneous protocols or other formats.

In operation, one or more customer systems 108 can register with the service system 104 to get access to the web service(s) offered by the CEaaS 102. In some implementations, the customer system does this as a way to access one or more application systems 110A-B. For example, the application system 110A is implemented in the customer system 108—that is, within the customer's own system—whereas the application system 110B is a separate system also connected to the network 106. This can help the customer more easily and flexibly obtain access to information in the application system—despite the presence of proprietary and/or heterogeneous protocols—no matter where the application system is physically implemented. In some implementations, the application system 110A and/or B can serve as an application system.

The registered customer system 108 can then send a request to the CEaaS 102 for some information. In some implementations, this request can seek information that is created or managed by a transactional system 112 (e.g., an SAP system) in the application system. For example, the transactional system can use a repository 114 (e.g., a database) for storing transactional and other business data. However, the request from the customer system 108 need not be originated in a client application that is specifically configured for the particular application system that is currently of interest.

Rather, the CEaaS 102 that receives the request can access tenant information 116 that is specific to this customer (e.g., specific to the specific customer system 108). Based on knowledge from the tenant information, the CEaaS determines which application system 110A-B is the relevant one, and can translate or otherwise convert the customer system's request into a format or protocol suitable for that application system.

The CEaaS can then forward such formatted request, for example via the network 106, for receipt by the particular application system.

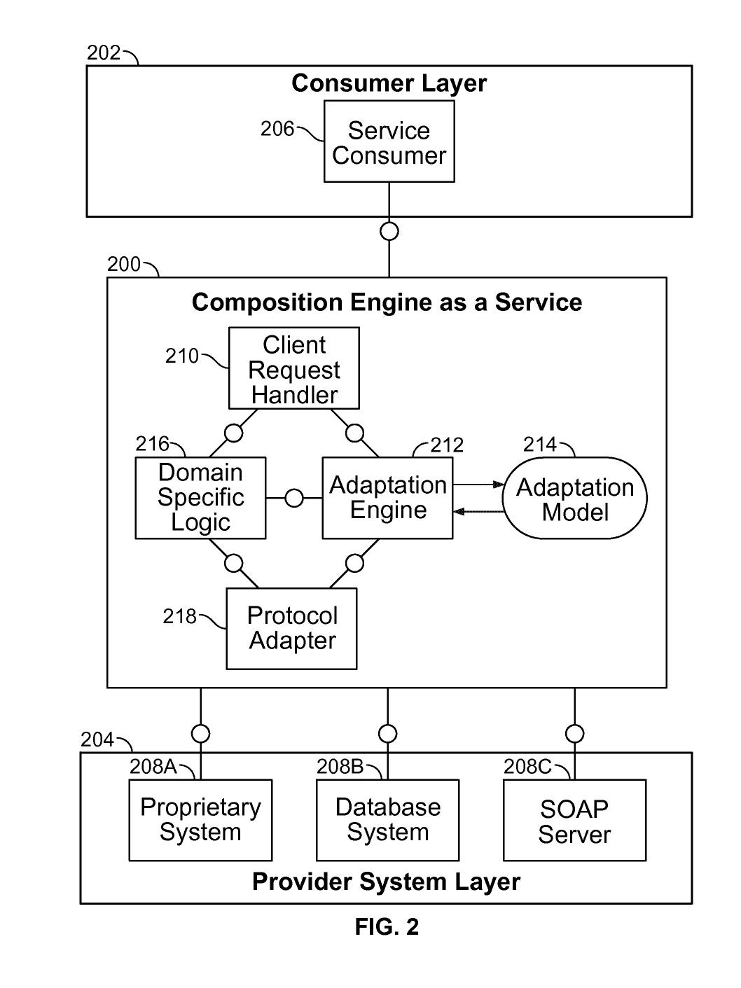

FIG. 2 shows an example of a Composition Engine as a Service (CEaaS) 200. In some implementations, the CEaaS 200 can be used in the system 100 (FIG. 1). For example, the CEaaS 200 can be implemented as part, or instead, of the CEaaS 102 (FIG. 1).

The CEaaS 200 is here implemented between a consumer layer 202 and a provider system layer 204. In some implementations, the consumer layer includes one or more service consumers 206. For example, the service consumer(s) can be one or more client applications (e.g., a browser) to be used for accessing the provider system layer 204, without such application(s) necessarily being specifically configured for the protocols and data formats used by the provider system layer. Rather, the client application(s) will consume the information as a service. For example, the engine functions as a service that composes and executes the suitable requests for the needed information, and exposes the received information in a format that the client can consume.

The provider system layer 204 can include one or more individual systems or other components. Here, the provider system layer includes components labeled a proprietary system 208A, a database system 208B and a SOAP server 208C, respectively. For example, the provider system layer can serve as an application system (e.g., as a backend) for one or more business systems. Each of the components 208A-C can be configured for interaction using one or more proprietary protocols.

The CEaaS 200 here includes one or more of each of a client request handler 210, an adaptation engine 212, an adaptation model 214, domain specific logic 216 and a protocol adapter 218. The client request handler 210 processes the request(s) issued by the service consumer(s) 206. The client request handler is primarily responsible for interpreting the request and routing it appropriately. For example, the client request handler can route the request to a particular component in the CEaaS 200 depending on the request and/or the service consumer 206.

The adaptation engine 212 can be used to adapt the retrieved information from the provider system layer 204 to a format that is required or accepted by the client. To do this, the adaptation engine can issue one or more requests to the protocol adapter 218 to retrieve the requested information. The protocol adapter is the component that is used to technically adapt any consumed protocol into an internal format that can be interpreted by the adaptation engine 212 or the domain specific logic 216. As one example, this can be an internal format for one or more particular components of the CEaaS 200. In some implementation, the internal format can be the same as an external format used by the CEaaS. The protocol adapter does not contain code that is specific to the particular domain (e.g., the domain of the service consumer 206 and/or the provider system), but rather uses the adaption model 214 to transform the retrieved data into the required format. The adaptation model can be specific to a tenant. For example, each tenant can have its specific logic implemented in the adaptation model.

The domain specific logic 216 can be added to the CEaaS 200 if the adaptation model 214 becomes too complex (e.g., with many tenants and/or application systems), or if the adaptation model otherwise does not satisfy the required flexibility. In some implementations, the domain specific logic is tenant specific as well.

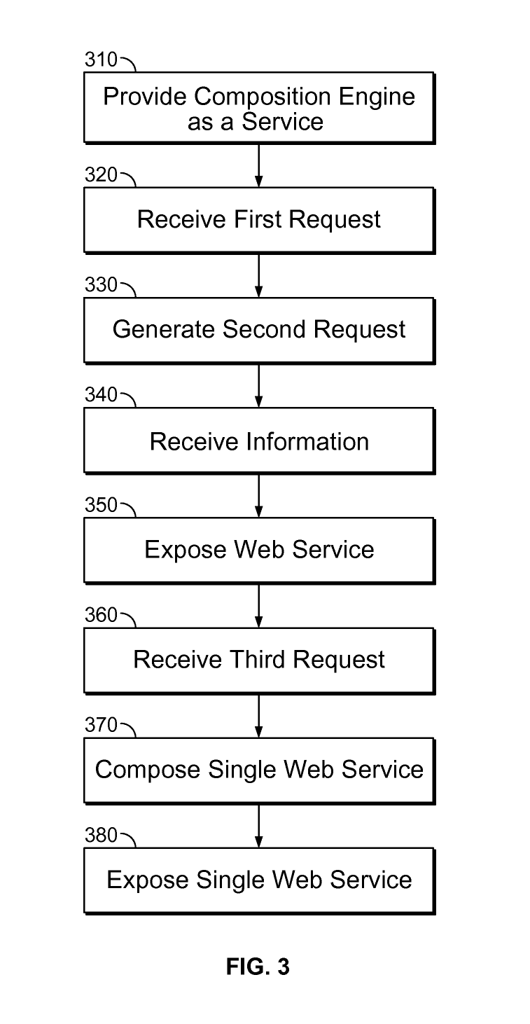

FIG. 3 shows an example of a method 300. The method can be performed by execution of code by one or more processors. For example, some or all of the method can be performed with regard to the system 100 (FIG. 1) and/or the CEaaS 200 (FIG. 2).

At 310, a composition engine is provided as a service. The composition engine as a service (CEaaS) is configured to receive requests from multiple service consumers (e.g., service consumer(s) 206 in FIG. 2) using any of multiple service consumer protocols.

At 320, a first request is received in the CEaaS from a service consumer operated by a customer. The first request conforms to a service consumer protocol (for example the protocol of the customer system 108 in FIG. 1).

At 330, the CEaaS generates a second request to one or more provider systems (e.g., in the provider system layer 204 in FIG. 2) in response to the first request. The second request conforming to a provider system protocol (e.g., of the proprietary system 208A, database system 208B and/or SOAP server 208C in FIG. 2). The CEaaS is configured to generate requests conforming to any of multiple provider system protocols.

At 340, information from the provider system is received by the CEaaS, and the CEaaS adapts (e.g., using the protocol adapter 218 in FIG. 2) the received information to conform to the service consumer protocol.

At 350, the CEaaS exposes a web service that makes the adapted information available to the service consumer. For example, the service consumer can access the web service using the network 106 (FIG. 1).

In some implementations, a user (e.g., from a customer or other service consumer) may wish to modify the provided web service(s) in some way. For example, the CEaaS can provide for composing one service from two or more existing services. Here, the CEaaS can receive, at 360, a request from the service consumer that identifies two or more web services provided by the CEaaS. For example, this can be two or more services configured to obtain different business data, such as from the same or different application systems. At 370, the CEaaS can compose a single web service from the identified two or more web services. Finally, at 380, the CEaaS can expose the composed single web service to the service consumer, for example using the network 106 (FIG. 1).

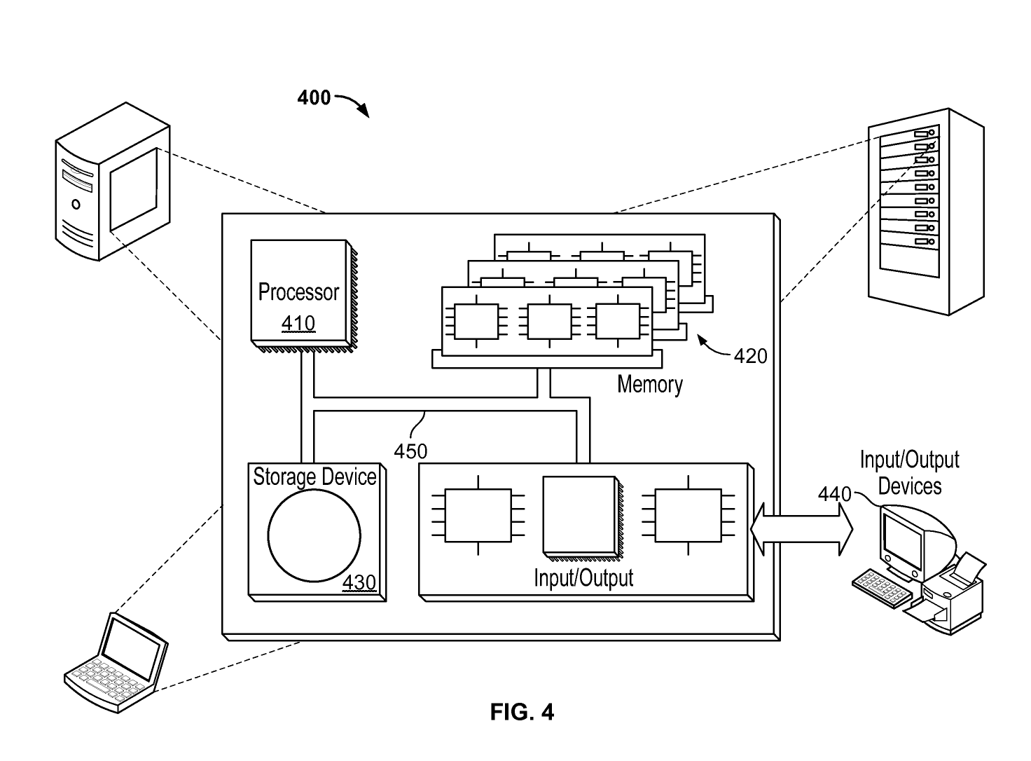

FIG. 4 is a schematic diagram of a generic computer system 400. The system 400 can be used for the operations described in association with any of the computer-implement methods described previously, according to one implementation. The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. The memory 420 is a volatile memory unit in some implementations and is a non-volatile memory unit in other implementations.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of this disclosure. Accordingly, other implementations are within the scope of the following claims.

What is claimed is:

1. A computer-implemented method for providing a composition engine as a service, the method comprising:
providing a composition engine as a service, the composition engine as a service configured to receive requests from multiple service consumers using any of multiple service consumer protocols;
receiving a first request in the composition engine as a service from a service consumer operated by a customer, the first request conforming to a service consumer protocol;
generating, by the composition engine as a service and in response to the first request, a second request to each of one or more provider systems, the second request conforming to a provider system protocol, the composition engine as a service configured to generate requests conforming to any of multiple provider system protocols;
receiving, by the composition engine as a service, information from the provider system, and adapting the received information to conform to the service consumer protocol; and
exposing, by the composition engine as a service, a web service that makes the adapted information available to the service consumer.

2. The computer-implemented method of claim 1, wherein the first request is received, in the composition engine as a service, by a client request handler that interprets the first request and routes the first request to an associated module.

3. The computer-implemented method of claim 1, further comprising adapting the service consumer protocol, by a protocol adapter in the composition engine as a service, into an internal format for the composition engine as a service.

4. The computer-implemented method of claim 3, wherein the internal format is for a component that includes an adaptation engine configured to adapt the received information to conform to the service consumer protocol, the adaptation engine using an adaptation model and not using domain-specific code associated with a domain of the provider system.

5. The computer-implemented method of claim 3, wherein the component includes domain-specific code associated with a domain of the provider system.

6. The computer-implemented method of claim 5, wherein the domain-specific code is also tenant-specific to the customer.

7. The computer-implemented method of claim 1, further comprising receiving, in the composition engine as a service, a request from the service consumer that identifies two or more web services provided by the composition engine as a service, composing, by the composition engine as a service, a single web service from the identified two or more web services, and exposing, by the composition engine as a service, the composed single web service to the service consumer.

8. A computer program product embodied in a non-transitory computer-readable storage medium and comprising instructions that when executed by a processor perform a method for providing a composition engine as a service, the method comprising:
providing a composition engine as a service, the composition engine as a service configured to receive requests from multiple service consumers using any of multiple service consumer protocols;
receiving a first request in the composition engine as a service from a service consumer operated by a customer, the first request conforming to a service consumer protocol;
generating, by the composition engine as a service and in response to the first request, a second request to each of one or more provider systems, the second request conforming to a provider system protocol, the composition engine as a service configured to generate requests conforming to any of multiple provider system protocols;
receiving, by the composition engine as a service, information from the provider system, and adapting the received information to conform to the service consumer protocol; and
exposing, by the composition engine as a service, a web service that makes the adapted information available to the service consumer.

9. The computer program product of claim 8, wherein the first request is received, in the composition engine as a service, by a client request handler that interprets the first request and routes the first request to an associated module.

10. The computer program product of claim 8, the method further comprising adapting the service consumer protocol, by a protocol adapter in the composition engine as a service, into an internal format for the composition engine as a service.

11. The computer program product of claim 10, wherein the internal format is for a component that includes an adaptation engine configured to adapt the received information to conform to the service consumer protocol, the adaptation engine using an adaptation model and not using domain-specific code associated with a domain of the provider system.

12. The computer program product of claim 10, wherein the component includes domain-specific code associated with a domain of the provider system.

13. The computer program product of claim 12, wherein the domain-specific code is also tenant-specific to the customer.

14. The computer program product of claim 8, the method further comprising receiving, in the composition engine as a service, a request from the service consumer that identifies two or more web services provided by the composition engine as a service, composing, by the composition engine as a service, a single web service from the identified two or more web services, and exposing, by the composition engine as a service, the composed single web service to the service consumer.

15. A system comprising:
one or more processors; and
a computer program product embodied in a non-transitory computer-readable storage medium and comprising instructions that when executed by a processor perform a method for providing a composition engine as a service, the method comprising:
providing a composition engine as a service, the composition engine as a service configured to receive requests from multiple service consumers using any of multiple service consumer protocols;
receiving a first request in the composition engine as a service from a service consumer operated by a customer, the first request conforming to a service consumer protocol;
generating, by the composition engine as a service and in response to the first request, a second request to each of one or more provider systems, the second request conforming to a provider system protocol, the composition engine as a service configured to generate requests conforming to any of multiple provider system protocols;
receiving, by the composition engine as a service, information from the provider system, and adapting the received information to conform to the service consumer protocol; and
exposing, by the composition engine as a service, a web service that makes the adapted information available to the service consumer.

16. The system of claim 15, wherein the first request is received, in the composition engine as a service, by a client request handler that interprets the first request and routes the first request to an associated module.

17. The system of claim 15, the method further comprising adapting the service consumer protocol, by a protocol adapter in the composition engine as a service, into an internal format for the composition engine as a service.

18. The system of claim 17, wherein the internal format is for a component that includes an adaptation engine configured to adapt the received information to conform to the service consumer protocol, the adaptation engine using an adaptation model and not using domain-specific code associated with a domain of the provider system.

19. The system of claim 17, wherein the component includes domain-specific code associated with a domain of the provider system.

20. The system of claim 15, the method further comprising receiving, in the composition engine as a service, a request from the service consumer that identifies two or more web services provided by the composition engine as a service, composing, by the composition engine as a service, a single web service from the identified two or more web services, and exposing, by the composition engine as a service, the composed single web service to the service consumer.
